(19) United States
(12) Patent Application Publication
(10) Pub. No.: US 2016/0071090 A1
(43) Pub. Date: Mar. 10, 2016

(54) Coin Card

(71) Applicant: Ireneusz Emil Pierzchala, Northbrook, IL (US)

(72) Inventor: Ireneusz Emil Pierzchala, Northbrook, IL (US)

(21) Appl. No.: 14/324,133

(22) Filed: Sep. 8, 2014

(51) Int. Cl. G06Q 20/34

(52) U.S. Cl. CPC G06Q 20/34

(57) ABSTRACT

The reloadable debit card will accept deposits in lieu of loose change every time the card is presented during the cash transaction at the cash register. Therefore, there is no need for customers and/or shoppers to deal with loose change, specifically coins.

The Coin Card is the financial concept design to free cash paying customers from the hassle of receiving and handling loose change (coins). Instead the loose change is deposited to the Coin Card through electronic transaction at the cash register during payment process.

Here, how it works:
1. The customer is buying merchandise or services. The cost is for example $15.35
2. The customer is paying with twenty-dollar bill.
3. The change is $4.65
4. The customer swipes his Coin Card
5. The customer is getting change: four one-dollar bills but 65 cents is deposited to the Coin Card
6. The customer is getting receipt for the transaction
7. The customer should have the option to deposit the whole change to the Coin Card
8. After some accumulation of funds The Coin Card can be used as the debit card

Benefits:
1. No more loose change in pockets, bags, backpacks etc.
2. No need to store coins in jars, piggy banks, drawers or other places.
3. Eliminate the possibility of loosing coins.
4. Lower operating cost for banks, retailers, fast food restaurants—all places that handling the coins
5. US Mint will not have to manufacture so many circulating coins every year.

The Coin Card claims:

1. Loose change from one cent up to ninety-nine cents is automatically deposited to the Coin Card at cash register.

2. There is no physical handling of loose change due to process of claim 1.

3. The process of claim 1 will lower the operating cost of banks and retailers.

4. The process used in claim 1 will limit the number of circulating coins.
